(19) United States
(12) Patent Application Publication
(10) Pub. No.: US 2011/0275264 A1
(43) Pub. Date: Nov. 10, 2011

(54) DURABLE FLAME RESISTANT FABRICS

(76) Inventors: Daniel T. McBride, Chesnee, SC (US); Warren W. Gerhardt, Greer, SC (US); John L. Sanchez, Moore, SC (US); Lei Zhang, Spartanburg, SC (US); Keith A. Keller, Spartanburg, SC (US); Jenny S. Kimbrell, Spartanburg, SC (US); Keenon Copeland, Inman, SC (US)

(21) Appl. No.: 12/777,203

(22) Filed: May 10, 2010

(51) Int. Cl. B32B 5/02; B05D 3/02; B32B 27/12

(52) U.S. Cl. 442/143; 442/145; 427/393.3

(57) ABSTRACT

Provided is a flame resistant fabric comprising a fabric substrate comprising cellulosic fibers and thermoplastic fibers, and a finish applied to the fabric substrate comprising a tetrahydroxymethyl phosphonium salt or a condensate thereof, a cross-linking agent, a brominated compound, and optionally a melamine resin. Also provided are methods of preparing the flame resistant fabric.

### BACKGROUND OF THE INVENTION

Flame resistant (FR) fabrics commonly comprise FR treated fabrics with a high cotton content. A high cotton content with FR treatment ensures char formation under flame, which along with a low thermoplastic content, prevents melt stick when burning. However, a large amount of cotton tends to produce more heat at a relatively low burning temperature (e.g., about 300° C.), which can increase the severity of burns.

Other FR fabrics comprise inherent FR fibers, such as FR rayon and aramid. However, problems arise from the use of such FR fabrics. For instance, the use of FR rayon creates abrasion problems in the resulting fabric, and the use of aramid in fabric construction increases cost.

Thus, there remains a need to provide an FR fabric that provides comfort and value yet has improved flame resistance.

### BRIEF SUMMARY OF THE INVENTION

The invention provides a flame resistant fabric comprising
a fabric substrate comprising cellulosic fibers and thermoplastic fibers,
and
a finish applied to the fabric substrate comprising
   a tetrahydroxymethyl phosphonium salt or a condensate thereof,
   a cross-linking agent,
   a brominated compound, and
   optionally a melamine resin.

The invention also provides a method of preparing a flame resistant fabric comprising
(i) providing a fabric substrate comprising cellulosic fibers and thermoplastic fibers;
(ii) contacting the fabric substrate with a solution comprising a brominated compound;
(iii) contacting the fabric substrate with a solution comprising a tetrahydroxymethyl phosphonium salt or a condensate thereof and a cross-linking agent and curing the treated fabric;
(iv) contacting the fabric substrate with a melamine resin; and
(v) finishing the fabric substrate to produce a flame resistant fabric.

The invention further provides a method of preparing a flame resistant fabric comprising
(i) providing a fabric substrate comprising cellulosic fibers and thermoplastic fibers; and then in either order
   (ii) contacting the fabric substrate with a solution comprising a brominated compound;
   (iii) contacting the fabric substrate with a solution comprising a tetrahydroxymethyl phosphonium salt or a condensate thereof and a cross-linking agent and curing the treated fabric;
and then
(iv) finishing the fabric substrate to produce a flame resistant fabric.

### DETAILED DESCRIPTION OF THE INVENTION

Because a greater amount of thermoplastic material and reduced cellulosic fiber can be used, the invention provides a flame resistant fabric with increased value (e.g., performance and/or function) at a reduced cost. Other benefits of the inventive flame resistant fabric include improved printability, enhanced abrasion resistance, improved durability (particularly to washing), improved comfort, reduced aramid content, no melt drip and/or melt stick of the thermoplastic material, increased protection to high heat flux events (e.g., flash fires, bomb blasts), and/or reduced second and third degree burns during a high energy flux event (e.g., electric arcs, bomb blasts). In particular, the flame resistant fabric of the invention comprises
a fabric substrate comprising cellulosic fibers and thermoplastic fibers,
and
a finish applied to the fabric substrate comprising
   a tetrahydroxymethyl phosphonium salt or a condensate thereof,
   a cross-linking agent,
   a brominated compound, and
   optionally a melamine resin.

The term “cellulosic fibers” as used herein generally refers to fibers composed of, or derived from, cellulose. Historically, the cellulosic content of blended fabrics contributes significantly to its hand, drape, moisture wicking, and breathability, characteristics which provide comfort to wearers thereof. Examples of suitable cellulosic fibers include cotton, rayon, linen, jute, hemp, cellulose acetate, and combinations thereof. Preferably, the cellulosic fibers are cotton. In some embodiments, when the finish has been applied to the fabric substrate, been heat-cured, and oxidized, at least the cellulosic fibers of the substrate have a pentavalent phosphorus compound polymerized in and around them.

The term “thermoplastic fibers” as used herein includes fibers that are permanently fusible and that may melt at higher temperatures. Examples of suitable thermoplastic fibers include polyesters (e.g., polyethylene terephthalate, polypropylene terephthalate, polybutylene terephthalate, and polylactic acid), polyolefins (e.g., polyethylene and polypropylene), polyamides (e.g., nylon 6, nylon 6,6, nylon 4,6, and nylon 12), polyphenylenesulfide, and any combination thereof. Preferably, the thermoplastic fibers are at least one material selected from the group consisting of a polyester, a polyamide, polyphenylenesulfide, and a combination thereof. More preferably, the thermoplastic is a nylon or a polyester.

In certain preferred embodiments, the flame resistant fabric comprises a fabric substrate comprising at least 35 wt % thermoplastic fibers (e.g., at least 40 wt %, at least 45 wt %, at least 50 wt %, at least 55 wt %, at least 60 wt %, at least 65 wt %, at least 70 wt %, at least 75 wt %, at least 80 wt %, or at least 85 wt %) based on the weight of the fabric substrate. With the inclusion of at least 35% thermoplastic fibers in the substrate fabric, the mechanical properties of the fabric can be improved (e.g., abrasion resistance, durability). Thus, the fabric substrate would comprise less than 65 wt % cellulosic fibers (e.g., less than 65 wt %, less than 60 wt %, less than 55 wt %, less than 50 wt %, less than 45 wt %, less than 40 wt %, less than 35 wt %, less than 30 wt %, less than 25 wt %, less than 20 wt %, less than 15 wt %) based on the weight of the fabric substrate.

If desired, one or more non-thermoplastic synthetic fibers, such as carbon fibers, aromatic polyamide (i.e., polyaramid fibers), polyacrylic fibers (including partially oxidized acrylonitrile), aromatic polyester, melamine formaldehyde polymer, polyimide, polysulfone, polyketone, polysulfone amide, mineral or silicate fibers (e.g., basalt, quartz, glass, aluminosilicate, etc.), and any combination thereof, can also be used in the fabric substrate. Typically, the total content of a non-thermoplastic synthetic fiber will be less than about 40 wt % (e.g., less than 30 wt %, less than 20 wt %, less than 15 wt %, less than 10 wt %) based on the weight of the fabric substrate. When non-thermoplastic synthetic fibers are used, preferably the content is at least 1 wt % (e.g., at least 2 wt %, at least 3 wt %, at least 4 wt %) based on the weight of the fabric substrate. These non-thermoplastic fibers can inherently be flame resistant and can contribute this and/or other desirable properties to the fabric.

The fabrics can be woven, knit, or nonwoven. For apparel applications, woven or knit constructions may be preferred. The fabric can have any suitable fabric weight for the intended application, for example, ranging from about 148 g/m² (4 oz/yd²) to about 445 g/m² (12 oz/yd²) for apparel and protective end uses.

Once the fabric is constructed (for example, woven, or knitted), it can be prepared using conventional textile processes, such as desizing, bleaching, and scouring. If desired, the fabric can be dyed and/or printed. The resulting fabric is then treated according to the process steps described herein to produce a flame resistant material.

The tetrahydroxymethyl phosphonium (“THP”) salt includes the salts of chloride, sulfate, acetate, carbonate, borate, and phosphate. Also, condensation products of THP may be employed. The condensate includes the condensation product of the THP salt with urea, guanazole, biguanide, or other nitrogen containing molecules which contain at least two reactive sites on a nitrogen atom or atoms. In certain embodiments, the tetrahydroxymethyl phosphonium salt is tetrahydroxymethyl phosphonium sulfate, a condensate of tetrahydroxymethyl phosphonium sulfate, tetrahydroxymethyl phosphonium chloride or a condensate of tetrahydroxymethyl phosphonium chloride. The THP salt or condensate thereof can be synthesized or commercially available. Synthetic methods can be for example, in Frank et al. (Textile Research Journal, November 1982, pages 678-693) and Frank et al. (Textile Research Journal, December 1982, pages 738-750). One example of a suitable THP is sold under the tradename PYROSAN® C-FR (having 72% solids and 10% active phosphorous) by Emerald Performance Materials.

The amount of THP salt or a condensate varies based on the fabric weight and construction. Typically, at least 0.5% (e.g., at least 1%, at least 1.5%, at least 2%, at least 2.5%, at least 3%, at least 3.5%, at least 4%, at least 4.5%) and less than 5% (e.g., less than 4.5%, less than 4%, less than 3.5%, less than 3%, less than 2.5%, less than 2%, less than 1.5%, less than 1%) of elemental phosphorus based on the weight of the untreated fabric is used. Preferably about 1%-3% phosphorous based on the weight of the untreated fabric is used.

The THP salt or its condensate and at least one cross-linking agent together form a reaction product. This reaction product is a cross-linked phosphorus-containing flame retardant polymer. The cross-linking agent is any suitable compound that enables the cross-linking and/or curing of THP. Suitable cross-linking agents include, for example, urea, a guanidine (i.e., guanidine, a salt thereof, or a guanidine derivative), guanyl urea, glycoluril, ammonia, an ammonia-formaldehyde adduct, an ammonia-acetaldehyde adduct, an ammonia-butyraldehyde adduct, an ammonia-chloral adduct, glucosamine, a polyamine (e.g., polyethyleneimine, polyvinylamine, polyetherimine, polyethyleneamine, polyacrylamide, chitosan, aminopolysaccharides), glycidyl ethers, isocyanates, blocked isocyanates and combinations thereof. In certain preferred embodiments, the cross-linking agent is urea or ammonia.

The guanidine salt is any suitable salt, such as the chloride, acetate, carbonate, bicarbonate, sulfate, or nitrate salt. Typical guanidine derivatives include arginine, guanidine hydroxide, nitroguanidine, aminoguanidine, 1,3-diaminoguanidine, dicyandiamide, 1-methyl-3-nitroguanidine, methylguanidine, acetylguanidine, phenylguanidine, diphenylguanidine, or a salt thereof.

The amount of cross-linking agent varies based on the fabric weight and construction. Typically, at least 0.1% (e.g., at least 1%, at least 3%, at least 5%, at least 7%, at least 10%, at least 15%, at least 18%, at least 20%) and less than 25% (e.g., less than 20%, less than 18%, less than 15%, less than 10%, less than 7%, less than 5%, less than 3%, less than 1%) cross-linking agent based on the weight of the untreated fabric is used.

In some embodiments, a fabric treated with THP salt or its condensate and at least one cross-linking agent is cured at a high temperature to effect or accelerate the condensation reaction. In this case, the term “high temperature” encompasses temperatures ranging from about 150° C. to about 190° C. and, more preferably, from about 160° C. to about 180° C. The high temperature can be applied for a period of time ranging from at least about 20 seconds to less than about 15 minutes (e.g., at least 1 min, at least 3 min, at least 5 min, at least 7 min, less than 12 min, less than 10 min, less than 7 min). In preferred embodiments, superheated steam (SHS) is used to cure the treated fabric.

In certain embodiments, it is desirable to contact the reaction product between the THP salt or condensate thereof, the cross-linking agent, and the fabric substrate with an oxidizing solution. The oxidizing step can enhance the durability (e.g., increases wearability after washing and/or bleach treatment) of the resulting flame resistant material. The oxidizing solution can contain any suitable oxidant, such as hydrogen peroxide, sodium perborate, or sodium hypochlorite. The amount of oxidant can vary depending on the actual materials used, but typically the amount of oxidant in the solution is at least 0.1% concentration (e.g., at least 0.5%, at least 0.8, at least 1%, at least 2%, at least 3% concentration) and is less than 20% concentration (e.g., less than 15%, less than 12%, less than 10%, less than 3%, less than 2%, less than 1% concentration).

The actual oxidation step can vary widely depending on the fabric substrate, THP salt or condensate thereof, and/or cross-linking agent. For example, if desired, the oxidizing solution can be warmed (e.g., up to 75° C., up to 70° C., up to 60° C., up to 50° C., up to 40° C., up to 30° C. relative to room temperature). The amount of time the fabric, THP salt or condensate thereof, and cross-linking agent need to be in contact with the oxidizing solution can also vary (e.g., at least 30 seconds, at least 1 min, at least 3 min, at least 5 min, at least 10 min). The oxidation step can be a continuous process (e.g., impregnating the cured fabric with a peroxide solution on a continuous range) or in a batch process (e.g., submerging the cured fabric in a peroxide solution in a bath, vat, or jet vessel).

After contacting the oxidizing solution, the cured fabric preferably is contacted with a neutralizing solution (e.g., a caustic solution with a pH of at least 8 (e.g., at least pH 9, at least pH 10, at least pH 11, at least pH 12)). The actual components of the caustic solution can widely vary, but suitable components include any strong base, such as alkalis. For example, sodium hydroxide (soda), potassium hydroxide (potash), calcium oxide (lime), or any combination thereof can be used in the neutralizing solution. The amount of base depends on the size of the bath and is determined by the ultimately desired pH level. A suitable amount of caustic in the solution is at least 0.1% concentration (e.g., at least 0.5%, at least 0.8, at least 1%, at least 2%, at least 3% concentration) and is less than 10% concentration (e.g., less than 8%, less than 6%, less than 5%, less than 3%, less than 2%, less than 1% concentration). The contact time of the treated fabric with the caustic solution varies, but typically is at least 30 seconds (e.g., at least 1 min, at least 3 min, at least 5 min, at least 10 min). If desired, the neutralizing solution can be warmed (e.g., up to 75° C., up to 70 ° C., up to 60° C., up to 50° C., up to 40° C., up to 30° C. relative to room temperature).

The brominated compound is any suitable compound that enhances the fabric's flame resistance performance. Thus, the brominated compound can also be described as a brominated flame retardant. Typical brominated compounds include hexabromocyclododecane (HBCD), tribromophenol allyl ether, brominated indan, brominated epoxy oligomers (BEOs), modified brominated epoxy oligomers (MBEOs), ethane-1,2-bis(pentabromophenyl), bis(tribromophenoxy) ethane, tris(tribromophenyl) cyanurate, tris-2,3-dibromopropyl-iso-cyanurate, ethylene bis-dibromonorbornane dicarboximide, dibromoneopentyl glycol, tribromoneopentyl alcohol, tris(tribromoneopentyl) phosphate, tetrabromophthalic acid, tetrabromophthalic anhydride, tetrabromophthalate diol, tetrabromophthalate derivatives (e.g., C₁₋₄ alkyl esters, amides imides, salts), pentabromodiphenyl oxide, decabromodiphenyl ether, octabromodiphenyl oxide (OCTA), tetrabromobisphenol A (TTBA) and its derivatives (e.g., ethers, brominated ethers, allyl ether derivative, phenoxy-terminated carbonate oligomer of TBBA, bis(2,3-dibromopropyl ether) of TBBA), high molecular weight brominated epoxy, ethylenebromobistetrabromophthalimide, brominated polystyrene, poly(dibromostyrene), poly-dibromophenylene oxide, a brominated acrylic copolymer, and any combination thereof. In certain preferred embodiments, the brominated compound is tetrabromobisphenol A, a derivative of tetrabromobisphenol A, tetrabromophthalic anhydride, a derivative of tetrabromophthalic anhydride, hexabromocyclododecane, decabromodiphenyl ether, decabromodiphenyl ethane, tris(tribromophenoxy) cyanurate, or any combination thereof. The brominated compound can be purchased commercially or synthesized.

In some embodiments, the brominated compound is a brominated acrylic copolymer comprising a bromo-substituted benzyl acrylate monomer. The bromo-substituted benzyl acrylate monomer can have the formula X-Y-Z, in which X is phenyl substituted with 3-5 (i.e., 3, 4, or 5) bromo substituents, Y is C₁₋₄ alkyl that is optionally substituted with 1-8 bromo substituents, and Z is an acrylic or methacrylic group. Preferably X has 5 bromo substituents. Some examples of brominated monomers in accordance with the present invention are tri-, tetra-, and pentabromo benzyl acrylate, tri-, tetra-, and pentabromo benzyl methacrylate, tri-, tetra-, and pentabromo phenyl ethyl (meth)acrylate, tri-, tetra-, and pentabromo phenyl mono-, di-, tri-, or tetra-bromo ethyl (meth)acrylate, tri-, tetra-, and pentabromo phenyl mono-, di-, tri-, tetra-, penta-, or hexabromo propyl (meth)acrylate, and tri-, tetra-, or pentabromo phenyl mono-, di-, tri-, tetra-, penta-, hexa-, septa-, or octabromo butyl (meth)acrylate. Additional brominated compounds are described in, e.g., U.S. Pat. Nos. 7,338,533 and 7,384,579 and U.S. Patent Application Publication 2007/0167550. A preferred bromo-substituted benzyl acrylate is a pentabromobenzyl acrylate (PBBMA) monomer.

The amount of brominated compound varies based on the fabric weight and construction. Typically, at least 1% (e.g., at least 3%, at least 5%, at least 7%, at least 10%, at least 12%) and less than 15% (e.g., less than 12%, less than 10%, less than 7%, less than 5%, less than 3%) of bromine based on the weight of the untreated fabric is used. Preferably about 2%-6% bromine compound based on the weight of the untreated fabric is used.

In certain preferred embodiments, an FR fabric of the invention includes a melamine resin. Melamine resin or melamine formaldehyde is a hard, thermosetting plastic material made from melamine (2,4,6-triamino-1,3,5 triazine) and formaldehyde by polymerization. A suitable melamine formaldehyde or a condensate thereof (e.g., melem, melam, melamine cyanurate, melamine phosphate, melamine borate, etc.) can be used, but preferably the melamine starting material is water soluble. Other suitable melamine starting materials are described in, e.g., U.S. Pat. No. 5,047,458, the entire contents of which are incorporated herein by reference. Melamine resin can be purchased commercially (e.g., AEROTEX® M3 resin from Emerald Performance Materials and CYMEL® from Cytec Industries Inc.).

The amount of melamine resin varies based on the fabric weight and construction. Typically, at least 0.5% (e.g., at least 1%, at least 3%, at least 5%, at least 7%, at least 10%, at least 12%) and less than 15% (e.g., less than 12%, less than 10%, less than 7%, less than 5%, less than 3%) melamine resin based on the weight of the untreated fabric is used. Preferably about 1%-5% melamine resin based on the weight of the untreated fabric is used.

If desired, a softening agent (also known as a “softener”) can be added to one of the treatment baths to improve the hand of the treated fabric. The softening agent selected for this purpose should not have a deleterious effect on the flammability of the resultant fabric. Suitable softeners include one or more of polyolefins, ethoxylated alcohols, ethoxylated ester oils, alkyl glycerides, alkylamines, quaternary alkylamines, halogenated waxes, and halogenated esters.

Other additives can be added to impart desired properties in the treated FR fabric. For example, suitable additives include wetting agents, surfactants, stain release agents (e.g., a hydrophilic stain release agent), stain repellency agents (e.g., a hydrophobic stain repellency agent), antimicrobial compounds, wicking agents, anti-static agents, antimicrobials, antifungals, and any combination thereof. The amount of other additives varies based on the fabric weight and construction.

Treatment of a substrate with a hydrophilic stain release agent generally results in a surface that exhibits a high surface energy. Hydrophilic stain release agents include ethoxylated polyesters, sulfonated polyesters, ethoxylated nylons, carboxylated acrylics, cellulose ethers or esters, hydrolyzed polymaleic anhydride polymers, polyvinylalcohol polymers, polyacrylamide polymers, hydrophilic fluorinated stain release polymers, ethoxylated silicone polymers, polyoxyethylene polymers, polyoxyethylene-polyoxypropylene copolymers, or any combination thereof. Hydrophilic fluorinated stain release polymers can be preferred stain release agents. Potentially preferred, non-limiting, compounds of this type include UNIDYNE® TG-992 and UNIDYNE® TG-9011, both available from Daikin Corporation; REPEARL® SR1100, available from Mitsubishi Corporation; ZONYL® 7910, available from DuPont; and NUVA® 4118 (liquid) from Clariant.

Treatment of a substrate with a hydrophobic stain repellency agent generally results in a surface that exhibits a low surface energy. Hydrophobic stain repellency agents include waxes, silicones, certain hydrophobic resins, fluoropolymers, or any combination thereof. Fluoropolymers can be preferred stain repellency agents. Potentially preferred compounds of this type include REPEARL® F8025 and REPEARL® F-89, both available from Mitsubishi Corp.; ZONYL® 7713, available from DuPont; E061, available from Asahi Glass; NUVA® N2114 (liquid), available from Clariant; and UNIDYNE® S-2000, UNIDYNE® 5-2001, UNIDYNE® S-2002, all of which are available from Daikin Corporation.

Any of the FR fabrics described herein can be tested for flame resistance. Suitable testing guidelines are set forth by National Fire Prevention Association (NFPA) Test Standard 701 entitled “Standard Methods for Fire Tests for Flame Resistant Textiles and Films.” A commonly used test used to measure performance is a full uniform test commonly referred to as “Pyroman” (ASTM 1930, NFPA 1971). In the Pyroman test, a mannequin is equipped with temperature sensors placed in a grid arrangement that measure the mannequin surface temperature after an initial timed burn. The measured temperature is recorded for a period of time after the initial burn and compared to established curves (Stoll curves) that represent a person's degree of skin damage or burn. The resulting burn map indicates the percent total body burn, second degree burns, and third degree burns.

If desired, tensile and tear strengths of the FR fabric can be evaluated, according to any known test method (e.g., ASTM D5034 and ASTM D2261).

The invention provides a method of preparing a flame resistant fabric comprising
(i) providing a fabric substrate comprising cellulosic fibers and thermoplastic fibers;
(ii) contacting the fabric substrate with a solution comprising a brominated compound;
(iii) contacting the fabric substrate with a solution comprising a tetrahydroxymethyl phosphonium salt or a condensate thereof and a cross-linking agent and curing the treated fabric;
(iv) contacting the fabric substrate with a melamine resin; and
(v) finishing the fabric substrate to produce a flame resistant fabric.

The finishing step (i.e., step (v)) can include mechanical surface treatment, rinsing, and/or drying the fabric. Mechanical surface treatments are described herein. Preferably, drying the treated fabric occurs at low temperatures. In this instance, the term “low temperature” encompasses temperatures generally less than about 210° C. and, most preferably, between about 100° C. and about 190° C. This low temperature drying can occur in any conventional type of drying apparatus for a time sufficient to remove from about 85% to about 100% of the moisture content of the fabric.

In certain embodiments, the method comprises after step (iii), contacting the fabric substrate with an oxidizing solution and then a neutralizing solution, as described herein. It is believed that the oxidant polymerizes the condensate into a pentavalent phosphorus compound.

If desired, step (iv) can be combined with step (ii). The combined steps (ii) and (iv) can be performed either prior to step (iii) or subsequent to step (iii). Likewise, step (iii) and step (iv) may be combined. The combined steps (iii) and (iv) may be performed prior to step (ii) or subsequent to step (ii).

The invention further provides a method of preparing a flame resistant fabric comprising
(i) providing a fabric substrate comprising cellulosic fibers and thermoplastic fibers; and then in either order
   (ii) contacting the fabric substrate with a solution comprising a brominated compound;
   (iii) contacting the fabric substrate with a solution comprising a tetrahydroxymethyl phosphonium salt or a condensate thereof and a cross-linking agent; and curing the treated fabric
and then
(iv) finishing the fabric substrate to produce a flame resistant fabric.

In certain preferred embodiments, step (ii) is performed prior to step (iii) for enhanced wash durability.

The finishing step (step (iv)) includes mechanical surface treatment, rinsing, and/or drying the fabric. Mechanical surface treatments and drying are described herein.

The method can further comprise after step (iii), contacting the cured fabric substrate with an oxidizing solution and then a neutralizing solution, as described herein.

In any of the methods described herein, the step of contacting a fabric with a certain treatment solution involves impregnating the fabric with the treatment chemistry (and any optional additives). Impregnating the fabric generally is accomplished by saturating the fabric with the solution to allow thorough penetration into the fabric. Preferably, this is accomplished by padding, i.e., passing the target fabric through an aqueous bath containing a solution of the flame retardant agent and any other desired additives. Padding can be done on any conventional equipment, but equipment having nip rollers is preferred to ensure adequate penetration of the bath chemistry into the fabric. Alternatively, the fabric can be sprayed or coated, using any known coating techniques.

To further enhance the fabric's hand, the fabric can optionally be treated with a mechanical surface treatment. A mechanical surface treatment typically relaxes stress imparted to the fabric during curing and fabric handling, breaks up yarn bundles stiffened during curing, and increases the tear strength of the treated fabric. Examples of suitable mechanical surface treatments include treatment with high-pressure streams of air or water (U.S. Pat. No. 4,918,795, U.S. Pat. No. 5,033,143, and U.S. Pat. No. 6,546,605), treatment with steam jets, needling, particle bombardment, ice-blasting, tumbling, stone-washing, constricting through a jet orifice, and treatment with mechanical vibration, sharp bending, shear, or compression. A sanforizing process may be used instead of, or in addition to, one or more of the above processes to improve the fabric's hand and to control the fabric's shrinkage. Additional mechanical treatments that may be used to impart softness to the treated fabric, and which may also be followed by a sanforizing process, include napping, napping with diamond-coated napping wire, gritless sanding, patterned sanding against an embossed surface, shot-peening, sand-blasting, brushing, impregnated brush rolls, ultrasonic agitation, sueding, engraved or patterned roll abrasion, and impacting against or with another material, such as the same or a different fabric, abrasive substrates, steel wool, diamond grit rolls, tungsten carbide rolls, etched or scarred rolls, or sandpaper rolls.

The following examples further illustrate the invention but, of course, should not be construed as in any way limiting its scope.

### EXAMPLE 1

This example demonstrates the preparation of a flame resistant polyester/cotton fabric.

A woven fabric comprising 65/35 polyester/cotton is padded with treatment bath 1 comprising 20 wt % TexFRon 45 MV (brominated acrylic copolymer; ICL Industrial Products) under 40 psi (70% wet pickup). The fabric is then fixed in superheated steam (SHS) at 140° C. for 7 min.

Next treatment bath 2 comprising 40% PYROSAN® DSH (THPS-urea precondensate; Emerald Performance Materials), 8.8% urea with optional softener is padded on to the fabric under 40 psi (70% wet pickup). The fabric is again fixed in SHS at 180° C. for 10 min and then contacted with an oxidizing solution comprising 8% hydrogen peroxide for 30 sec to 2 min. To neutralize the fabric, the fabric is dipped in a 2% caustic solution.

Treatment bath 3 comprising 20% AEROTEX® M3 resin (melamine formaldehyde resin) and 0.5% Catalyst KR (available from Milliken Chemical) is padded on to the fabric under 40 psi (70% wet pickup). The fabric is fixed in SHS at 140° C. for 7 min. The treated fabric is then rinsed with water and dried.

The treated fabric (6.7 ounces) was sewn into a standard UL coverall and tested for flame resistance in a 3 second burn Pyroman test and compared to a commercially available FR 88:12 cotton:nylon fabric (6.5 ounces). The results are shown in Table 1.

TABLE 1

| | total body burn | second degree | third degree |
|---|---|---|---|
| FR fabric | (head not included) | burn | burn |
| 88:12 NyCo | 38.3% | 33.9% | 4.4% |
| (comparative) | | | |
| 65:35 polyester/ | 28.3% | 28.3% | 0.4% |
| cotton (inventive) | | | |

The inventive FR fabric resulted in a decrease of total body burn, and second and third degree burns compared to a commercially available FR 88:12 cotton:nylon fabric. In addition, melt sticking was not observed in the 3 second burn Pyroman test, indicating that the molten polyester is less likely to stick to the skin.

### EXAMPLE 2

This example demonstrates the preparation of a flame resistant cotton/nylon 66 fabric.

A woven fabric comprising 50/50 cotton/nylon 6,6 is padded with treatment bath 1 (90% wpu) comprising 35% PRYOSAN® DSH (THPS precondensate; Emerald Performance Materials), 8.8% urea, and 10% tetrabromophthalic acid, adjusting to pH 6 with caustic, softened with 5% softener (MILLITEX® FRAC-II, Milliken Chemical). The fabric is fixed in SHS at 180° C. for 10 min and then contacted with an oxidizing solution comprising 8% hydrogen peroxide for 30 sec. To neutralize the fabric, the fabric is dipped in a 2% caustic solution.

Next, treatment bath 2 comprising 10% AEROTEX® M3 resin (melamine formaldehyde resin; Emerald Performance Materials) is padded on to the fabric. The fabric is fixed in SHS at 120° C. for 5 min. The treated fabric is then dried.

The inventive FR fabric was sewn into a UL coverall and tested for flame resistance in a 4 second burn Pyroman test and compared to a commercially available FR cotton/nylon/aramid fabric (approximately 30/30/40). The FR cotton/nylon/aramid fabric demonstrated a total result of 49% body burn with no melt stick. In comparison, the inventive treated fabric also exhibited no melt stick in the Pyroman test and had a total body burn of 49%. These results indicate that the inventive treated fabric without any aramid content exhibited similar results in the Pyroman burn test compared to the commercially available FR cotton/nylon/aramid fabric.

### EXAMPLE 3

This example demonstrates the preparation of a flame resistant cotton/nylon 6,6/KEVLAR® fabric.

A woven fabric comprising 50/40/10 cotton/nylon 6,6/KEVLAR® is padded with, treatment bath 1 comprising 25 wt % TexFRon 45 MV (brominated acrylic copolymer) is padded on to the fabric. The fabric is then fixed in SHS at 140° C. for 7 min and dried.

Next, treatment bath 2 comprising 25% PYROSAN® DSH (THPS precondensate; Emerald Performance Materials) and 8.8% urea with optional softener. The fabric is fixed in SHS at 180° C. for 6 min and then contacted with an oxidizing solution comprising 8% hydrogen peroxide for 30 sec. To neutralize the fabric, the fabric is dipped in a 2% caustic solution.

The treated fabric was sewn into an FR army combat uniform (FR-ACU) garment and tested for flame resistance in a 4 second burn Pyroman test and compared to a commercially available FR cotton/nylon/aramid fabric (approximately 30/30/40) in the same garment configuration. The commercial fabric demonstrated a total body burn of 32%. In comparison, the inventive treated fabric exhibited no melt stick in the Pyroman test and had a total body burn of 33%. These results indicate that the inventive treated fabric had a greatly reduced aramid content compared to the commercially available FR cotton/nylon/aramid fabric, yet exhibited similar results in the Pyroman burn test.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A flame resistant fabric comprising
a fabric substrate comprising cellulosic fibers and thermoplastic fibers, and
a finish applied to the fabric substrate comprising
a tetrahydroxymethyl phosphonium salt or a condensate thereof,
a cross-linking agent,
a brominated compound, and
optionally a melamine resin.

2. The flame resistant fabric of claim 1, wherein the finish comprises a melamine resin.

3. The flame resistant fabric of claim 1, wherein the cellulosic fibers are cotton.

4. The flame resistant fabric of claim 1, wherein the thermoplastic fibers are selected from the group consisting of a polyester, a polyamide, and polyphenylenesulfide.

5. The flame resistant fabric of claim 1, wherein the fabric substrate comprises at least 35 wt % thermoplastic fibers.

6. The flame resistant fabric of claim 1, wherein the tetrahydroxymethyl phosphonium salt or a condensate thereof and the cross-linking agent form a cross-linked phosphorus-containing flame retardant polymer.

7. The flame resistant fabric of claim 1, wherein the tetrahydroxymethyl phosphonium salt is tetrahydroxymethyl phosphonium sulfate, a condensate thereof, tetrahydroxymethyl phosphonium chloride, or a condensate thereof.

8. The flame resistant fabric of claim 1, wherein the brominated compound is tetrabromobisphenol A, a derivative of tetrabromobisphenol A, tetrabromophthalic anhydride, a derivative of tetrabromophthalic anhydride, hexabromocyclododecane, decabromodiphenyl ether, decabromodiphenyl ethane, tris(tribromophenoxy) cyanurate, or any combination thereof.

9. The flame resistant fabric of claim 1, wherein the brominated compound is an acrylic copolymer comprising a bromo-substituted benzyl acrylate monomer.

10. The flame resistant fabric of claim 9, wherein the bromo-substituted benzyl acrylate is a pentabromobenzyl acrylate monomer.

11. The flame resistant fabric of claim 1, wherein
the cellulosic fibers are cotton,
the thermoplastic fibers comprise a polyamide,
the tetrahydroxymethyl phosphonium salt is tetrahydroxymethyl phosphonium sulfate or a condensate thereof,
the cross-linking agent is urea, and
the brominated compound is an acrylic copolymer comprising a pentabromobenzyl acrylate monomer.

12. A method of preparing a flame resistant fabric comprising
(i) providing a fabric substrate comprising cellulosic fibers and thermoplastic fibers;
(ii) contacting the fabric substrate with a solution comprising a brominated compound;
(iii) contacting the fabric substrate with a solution comprising a tetrahydroxymethyl phosphonium salt or a condensate thereof and a cross-linking agent and curing the treated fabric;
(iv) contacting the fabric substrate with a melamine resin; and
(v) finishing the fabric substrate to produce a flame resistant fabric.

13. The method of claim 12, further comprising after step (iii), contacting the fabric substrate with an oxidizing solution and then a neutralizing solution.

14. The method of claim 12, wherein step (iv) is combined with step (ii) and is performed prior to step (iii) or subsequent to step (iii).

15. A method of preparing a flame resistant fabric comprising
(i) providing a fabric substrate comprising cellulosic fibers and thermoplastic fibers;
and then in either order
(ii) contacting the fabric substrate with a solution comprising a brominated compound;
(iii) contacting the fabric substrate with a solution comprising a tetrahydroxymethyl phosphonium salt or a condensate thereof and a cross-linking agent and curing the treated fabric;
and then
(iv) finishing the fabric substrate to produce a flame resistant fabric.

16. The method of claim 15, further comprising after step (iii), contacting the fabric substrate with an oxidizing solution and then a neutralizing solution.

17. The method of claim 15, wherein the cellulosic fibers are cotton.

18. The method of claim 15, wherein the thermoplastic fibers are selected from the group consisting of a polyester, a polyamide, and polyphenylenesulfide.

19. The method of claim 15, wherein the fabric substrate comprises at least 35 wt % thermoplastic fibers.

20. The method of claim 15, wherein the tetrahydroxymethyl phosphonium salt is tetrahydroxymethyl phosphonium sulfate, a condensate thereof, tetrahydroxymethyl phosphonium chloride, or a condensate thereof.

21. The method of claim 15, wherein the brominated compound is an acrylic copolymer comprising a bromo-substituted benzyl acrylate monomer.

22. The method of claim 21, wherein the bromo-substituted benzyl acrylate is a pentabromobenzyl acrylate monomer.
